(19) United States
(12) Patent Application Publication
(10) Pub. No.: US 2018/0306715 A1
(43) Pub. Date: Oct. 25, 2018

(54) SMOKE-DETECTING PHOTOSENSOR

(71) Applicant: Murata Manufacturing Co., Ltd., Nagaokakyo-shi (JP)

(72) Inventor: Tsutomu YAMASAKI, Nagaokakyo-shi (JP)

(21) Appl. No.: 15/826,748

(22) Filed: Nov. 30, 2017

(30) Foreign Application Priority Data
Apr. 20, 2017 (JP) 2017-083667

(51) Int. Cl. G01N 21/53

(52) U.S. Cl. CPC G01N 21/53; G01N 2201/0639

(57) ABSTRACT

A light-emission-side prism accommodates a light-emitting element and is disposed in a light-emission guide hole extending in a light-emission axis direction. A light-reception-side prism accommodates a light-receiving element and is disposed in a light-reception guide hole extending in a light-reception axis direction. The light-emission-side prism has a total-reflection surface that causes light from the light-emitting element to be directed in the light-emission axis direction and a lens surface that causes light emitted from the total-reflection surface to be condensed. The light-reception-side prism includes a lens surface that causes scattered light entering from a smoke monitoring area in the light-reception axis direction to be condensed and a total-reflection surface that causes light condensed by the lens surface to be directed toward the light-receiving element.

### CROSS REFERENCE TO RELATED APPLICATIONS

This application claims the benefit of priority to Japanese Patent Application No. 2017-083667 filed on Apr. 20, 2017. The entire contents of this application are hereby incorporated herein by reference.

### BACKGROUND OF THE INVENTION

### 1. Field of the Invention

The present invention relates to a smoke-detecting photosensor that optically detects smoke.

### 2. Description of the Related Art

A known smoke-detecting photosensor irradiates a smoke monitoring area with light from a light-emitting element to detect scattered light due to smoke particles by using a light-receiving element (see, for example, Japanese Unexamined Patent Application Publication No. 4-160696). In a smoke-detecting photosensor disclosed in Japanese Unexamined Patent Application Publication No. 4-160696, the light-emitting element and the light-receiving element are mounted on a circuit board disposed in a housing. A light-emission mirror and a light-reception mirror are provided in the housing. The light-emission mirror deflects the light from the light-emitting element such that the light enters the smoke monitoring area at a predetermined angle, and the light-reception mirror deflects scattered light from the smoke monitoring area such that the scattered light is incident on the light-receiving element.

The light-emitting element of the smoke-detecting photosensor disclosed in Japanese Unexamined Patent Application Publication No. 4-160696 is an LED (light-emitting diode), the divergence angle of the light from the light-emitting element tends to increase, and some of the light from the light-emitting element does not reach a reflective surface of the light-emission mirror. For this reason, a light-shielding wall is disposed between the light-emitting element and the light-emission mirror to prevent some of the light from being lost. This means that the light-emitting element emits light that is not conducive to smoke detection, and there is a problem in that a loss of light occurs.

The light-emitting element and the light-emission mirror are separately installed in the housing, and the light-receiving element and the light-reception mirror are separately installed in the housing. For this reason, the accuracy of positioning thereof is likely to decrease, and there is a problem in that the light collection efficiency of the scattered light to the light-receiving element is likely to decrease. The reflective surface of the light-emission mirror is formed of a deposited aluminum thin film. In this case, the reflectance of the light-emission mirror tends to be degraded over time, and there is a problem in that the use of the light-emission mirror for a long period of time reduces reliability.

### SUMMARY OF THE INVENTION

Preferred embodiments of the present invention provide smoke-detecting photosensors that are able to reduce degradation over time with increased reliability.

According to a preferred embodiment of the present invention, a smoke-detecting photosensor that irradiates a smoke monitoring area with light from a light-emitting element and that detects scattered light due to a smoke particle by using a light-receiving element includes a housing in which the light-emitting element and the light-receiving element are disposed on one surface side, a light-emission guide hole that is provided in the housing, that extends in a light-emission axis direction different from an optical axis of the light-emitting element, and through which the light from the light-emitting element is guided to the smoke monitoring area on the other surface side, a light-reception guide hole that is provided in the housing, that extends in a light-reception axis direction different from the light-emission axis direction and different from an optical axis of the light-receiving element, and through which scattered light from the smoke monitoring area is guided to the light-receiving element, a light-emission-side prism that accommodates the light-emitting element and that is disposed in the light-emission guide hole, and a light-reception-side prism that accommodates the light-receiving element and that is disposed in the light-reception guide hole. The light-emission-side prism includes a total-reflection surface that causes the light from the light-emitting element to be directed in the light-emission axis direction due to total reflection at an interface with an outside and a lens surface that is located on a light exit surface and that causes light emitted from the total-reflection surface to be condensed. The light-reception-side prism includes a lens surface that is located on a light entrance surface and that causes the scattered light entering from the smoke monitoring area in the light-reception axis direction to be condensed and a total-reflection surface that causes light condensed by the lens surface to be directed toward the light-receiving element due to total reflection at an interface with the outside.

According to a preferred embodiment of the present invention, the total-reflection surface of the light-emission-side prism may preferably be a flat inclined surface that is inclined from the optical axis of the light-emitting element.

According to a preferred embodiment of the present invention, the total-reflection surface of the light-emission-side prism may preferably be a toroid surface including curvatures that are different between a vertical direction parallel to the optical axis of the light-emitting element and a horizontal direction perpendicular to the optical axis of the light-emitting element, and a radius of curvature of the total-reflection surface in the vertical direction is larger than a radius of curvature of the total-reflection surface in the horizontal direction.

According to a preferred embodiment of the present invention, a divergence angle of light of the light-emitting element may preferably be about 30° or less.

According to a preferred embodiment of the present invention, the light-emitting element and the light-emission-side prism may preferably be mounted on a first substrate, and a direction of the optical axis of the light-emitting element may preferably be a vertical or substantially vertical direction perpendicular or substantially perpendicular to the first substrate. The light-receiving element and the light-reception-side prism may be mounted on a second substrate, and a direction of the optical axis of the light-receiving element may be the vertical or substantially vertical direction perpendicular or substantially perpendicular to the second substrate.

According to a preferred embodiment of the present invention, the light-emission-side prism accommodates the light-emitting element and is disposed in the light-emission guide hole, and the light-reception-side prism accommodates the light-receiving element and is disposed in the light-reception guide hole. Since the light-emission-side prism includes the total-reflection surface, total reflection occurs at the total-reflection surface due to a difference in the refractive index between the inside and the outside of the light-emission-side prism. For this reason, the light from the light-emitting element is able to be directed in the light-emission axis direction by using the total-reflection surface of the light-emission-side prism. Thus, the light from the light-emitting element is able to be supplied to the smoke monitoring area via the light-emission guide hole. In addition, since the light-emission-side prism includes the lens surface, the light from the light-emitting element is able to be condensed in the smoke monitoring area. For this reason, the light is able to be scattered in the smoke monitoring area even when the output of the light-emitting element is low.

Since the light-reception-side prism includes the total-reflection surface, total reflection occurs at the total-reflection surface due to a difference in the refractive index between the inside and the outside of the light-reception-side prism. For this reason, the scattered light entering from the smoke monitoring area in the light-reception axis direction is able to be directed toward the light-receiving element by using the total-reflection surface of the light-reception-side prism. Thus, the scattered light entering via the light-reception guide hole is able to be supplied to the light-receiving element. In addition, since the light-reception-side prism includes the lens surface, a luminous flux is able to be condensed on the light-receiving element. For this reason, the scattered light is able to be condensed on the light-receiving element and detected even when the scattered light in the smoke monitoring area is weak. Consequently, the light-emitting element is able to be operated with a low output, and energy consumption is able to be decreased.

The light-emission-side prism and the light-reception-side prism have a small variation in the refractive index over time. For this reason, the reflectance of the light-emission-side prism and the light-reception-side prism scarcely changes, and high reliability is achieved. The light-emission-side prism accommodates the light-emitting element, and the light-reception-side prism accommodates the light-receiving element. For this reason, the accuracy of positioning of the prisms and the elements can be higher than that in the case where the prisms and the elements are separately installed, and the light collection efficiency of the scattered light to the light-receiving element is increased.

According to a preferred embodiment of the present invention, the total-reflection surface of the light-emission-side prism is preferably a flat inclined surface that is inclined from the optical axis of the light-emitting element. For this reason, the light from the light-emitting element is able to be directed in the light-emission axis direction due to total reflection at the inclined surface of the light-emission-side prism.

According to a preferred embodiment of the present invention, the total-reflection surface of the light-emission-side prism is preferably a toroid surface including curvatures and that is different between the vertical direction parallel to the optical axis of the light-emitting element and the horizontal direction perpendicular to the optical axis of the light-emitting element, and the radius of curvature of the total-reflection surface in the vertical direction is larger than the radius of curvature of the total-reflection surface in the horizontal direction. For this reason, even when the light from the light-emitting element tends to diverge in the horizontal direction more than in the vertical direction, the light-emission-side prism including the total-reflection surface, which is the toroid surface, is able to inhibit the light from diverging in the horizontal direction, and the light from the light-emitting element is able to be condensed in the smoke monitoring area.

According to a preferred embodiment of the present invention, since the divergence angle of light of the light-emitting element is preferably about 30° or less, the light emitted from the light-emitting element is able to be totally reflected by the small light-emission-side prism unlike the case where the divergence angle of light is large.

According to a preferred embodiment of the present invention, the direction of the optical axis of the light-emitting element is preferably the vertical or substantially vertical direction perpendicular or substantially perpendicular to the first substrate, and the direction of the optical axis of the light-receiving element is preferably the vertical or substantially vertical direction perpendicular or substantially perpendicular to the second substrate. Since the light from the light-emitting element is able to be totally reflected in the light-emission axis direction by using the light-emission-side prism, the light emitted along the optical axis of the light-emitting element is able to be condensed in the smoke monitoring area. Since the scattered light entering in the light-reception axis direction is able to be totally reflected toward the light-receiving element by using the light-reception-side prism, the scattered light in the smoke monitoring area is able to be incident on the light-receiving element along the optical axis.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a smoke-detecting photosensor according to a first preferred embodiment of the present invention.

FIG. 2 is a sectional view of the smoke-detecting photosensor in FIG. 1.

FIG. 3 is a plan view of the smoke-detecting photosensor in FIG. 1.

FIG. 4 is an exploded sectional view of a housing in FIG. 2.

FIG. 5 is an enlarged sectional view of a light-emitting element and a light-emission-side prism in FIG. 2.

FIG. 6 is an enlarged sectional view of the light-emitting element and the light-emission-side prism viewed from the direction of an arrow VI-VI in FIG. 5.

FIG. 7 is an enlarged sectional view of a light-receiving element and a light-reception-side prism in FIG. 2.

FIG. 8 is an enlarged perspective view of the light-emitting element and the light-emission-side prism.

FIG. 9 is an enlarged perspective view of the light-receiving element and the light-reception-side prism.

FIG. 10 is a sectional view of a smoke-detecting photosensor according to a second preferred embodiment of the present invention at the same position as in FIG. 2.

FIG. 11 is an enlarged sectional view of a light-emitting element and a light-emission-side prism in FIG. 10 at the same position as in FIG. 5.

FIG. 12 is an enlarged sectional view of a light-receiving element and a light-reception-side prism in FIG. 10 at the same position as in FIG. 7.

FIG. 13 is an enlarged sectional view of the light-emission-side prism in FIG. 10 alone.

FIG. 14 is an enlarged sectional view of the light-emission-side prism viewed from the direction of an arrow XIV-XIV in FIG. 13.

### DETAILED DESCRIPTION OF THE PREFERRED EMBODIMENTS

Smoke-detecting photosensors according to preferred embodiments of the present invention will hereinafter be described in detail with reference to the accompanying drawings.

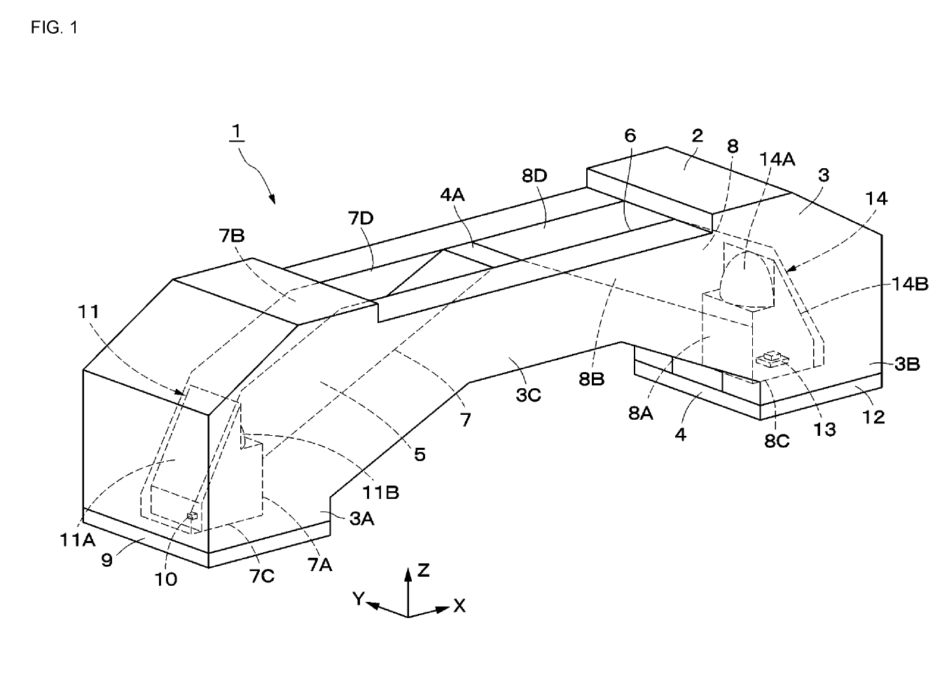

FIG. 1 to FIG. 9 illustrate a smoke-detecting photosensor 1 according to a first preferred embodiment of the present invention. For convenience of the description, the X-direction is referred to as a length direction, the Y-direction is referred to as a width direction, and the Z-direction is referred to as a height direction.

The smoke-detecting photosensor 1 includes a housing 2, a light-emission guide hole 7, a light-reception guide hole 8, a light-emitting element 10, a light-emission-side prism 11, a light-receiving element 13, and a light-reception-side prism 14.

The housing 2 includes a box-shaped main body 3 that extends in the length direction and that opens on one surface side (bottom surface side) in the height direction, and a bottom portion 4 that is located on the bottom surface side of the main body 3 and that covers a cavity. The light-emitting element 10 and the light-receiving element 13 are disposed on the bottom surface side of the housing 2.

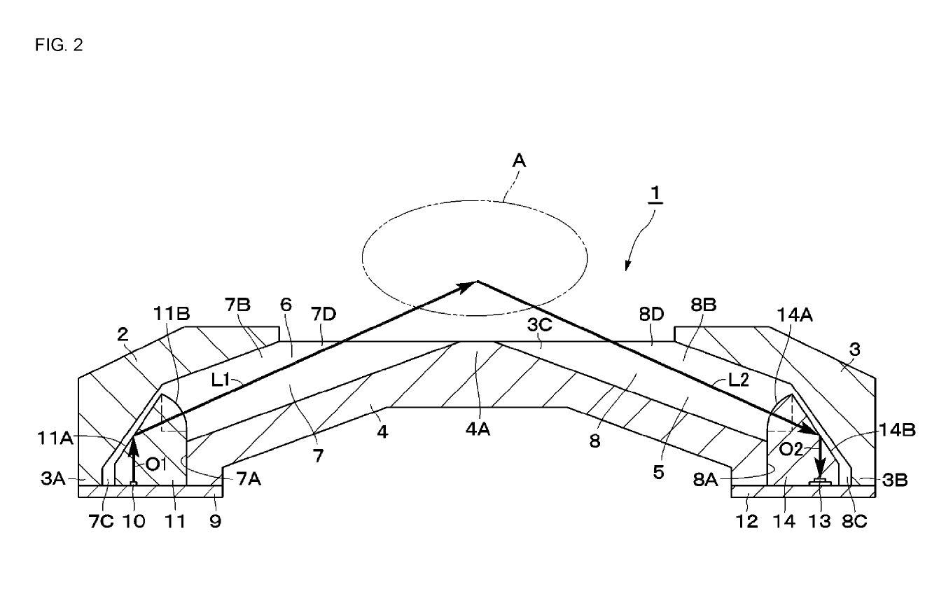

The main body 3 includes a light-emission-side leg portion 3A that is located on one side (left-hand side in FIG. 2) in the length direction and that protrudes toward the bottom surface side, a light-reception-side leg portion 3B that is located on the other side (right-hand side in FIG. 2) in the length direction and that protrudes toward the bottom surface side, and a coupling portion 3C that couples the light-emission-side leg portion 3A and the light-reception-side leg portion 3B and that extends in the length direction.

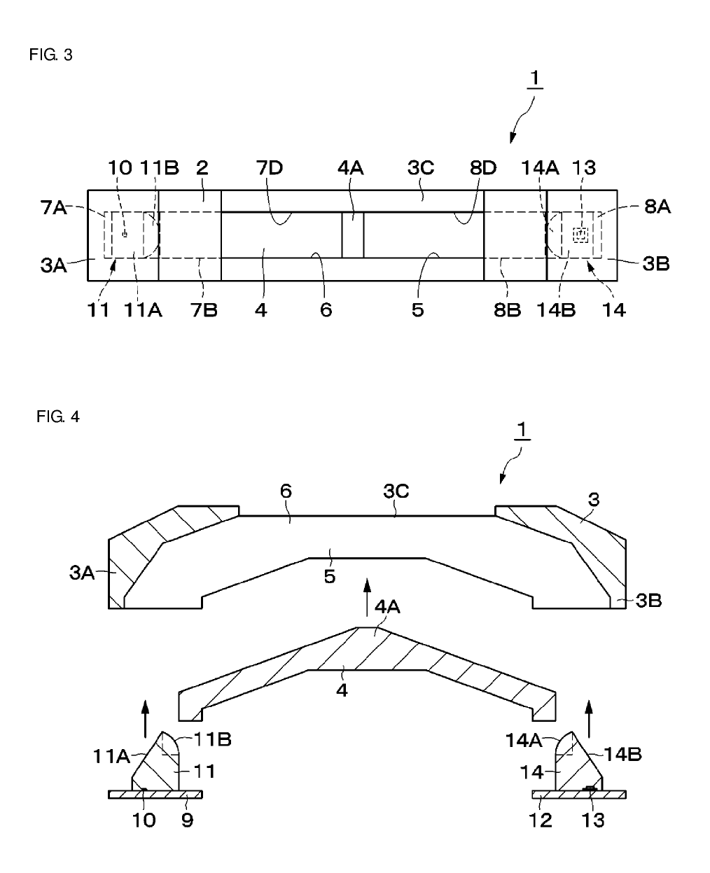

As illustrated in FIG. 4, a groove 5 extending in the length direction is provided on the bottom surface side of the main body 3. The groove 5 extends through the coupling portion 3C from the light-emission-side leg portion 3A to the light-reception-side leg portion 3B. As illustrated in FIG. 3 and FIG. 4, a through-hole 6 that is located at the center or approximate center of the coupling portion 3C in the length direction and that extends through the main body 3 in the height direction is provided from the other surface side (upper surface side) of the main body 3 in the height direction. The through-hole 6 is in communication with the groove 5.

The bottom portion 4 preferably has a triangular or substantially triangular shape and is inserted in the groove 5 of the main body 3. As illustrated in FIG. 2, the bottom portion 4 is attached to the main body 3 with a space interposed therebetween in the height direction and covers the opening side (lower side in FIG. 2) of the groove 5. A shield protrusion 4A that extends toward the upper surface side of the main body 3 is provided at the center or approximate center of the bottom portion 4 in the length direction. The shield protrusion 4A prevents light from the light-emitting element 10 from being directly incident on the light-receiving element 13. The shield protrusion 4A preferably has an area smaller than the opening area of the through-hole 6 and is inserted in the through-hole 6 at the center or approximate center thereof in the length direction. Thus, the space provided between the main body 3 and the bottom portion 4 in the height direction is divided into two spaces by the shield protrusion 4A. Consequently, in the housing 2, the light-emission guide hole 7 that is located on one side (left-hand side in FIG. 2) in the length direction is defined by one of the spaces, and the light-reception guide hole 8 that is located on the other side (right-hand side in FIG. 2) in the length direction is defined by the other space.

The light-emission guide hole 7 is provided in the housing 2 and extends in a light-emission axis direction L1 different from the optical axis O1 of the light-emitting element 10. The light-emission guide hole 7 is located nearer than the shield protrusion 4A to the one side in the length direction and is bent in an L-shape. The light-emission guide hole 7 includes a vertical hole portion 7A extending along the optical axis O1 of the light-emitting element 10 and a diagonal hole portion 7B that is continuous with the vertical hole portion 7A and that extends in a diagonal direction that coincides with the light-emission axis direction L1. The length of the diagonal hole portion 7B in the light-emission axis direction L1 is preferably larger than the width and the height in directions perpendicular or substantially perpendicular to the light-emission axis direction L1. Thus, the diagonal hole portion 7B is an elongated straight hole.

The light-emission axis direction L1 is inclined from the optical axis O1 of the light-emitting element 10 toward the light-receiving element 13 and is inclined toward the upper surface side (upper side) with respect to the length direction (X-direction). The light-emission guide hole 7 guides the light from the light-emitting element 10 to a smoke monitoring area A on the upper surface side.

The light-emission guide hole 7 includes an element installation portion 7C that opens on the bottom surface side of the housing 2 and a light exit window 7D that opens on the upper surface side of the housing 2. The light-emitting element 10 is installed in the element installation portion 7C. The light from the light-emitting element 10 exits from the light exit window 7D toward the smoke monitoring area A. The light exit window 7D is defined by a portion of the through-hole 6 nearer than the shield protrusion 4A to the one side in the length direction and opens on the upper side of the housing 2.

The light-reception guide hole 8 is provided in the housing 2 and extends in a light-reception axis direction L2 different from the light-emission axis direction L1 and different from the optical axis O2 of the light-receiving element 13. The light-reception guide hole 8 is located nearer than the shield protrusion 4A to the other side in the length direction and is bent in an L-shape.

For example, the light-reception guide hole 8 is preferably symmetric (symmetric with respect to a line or a plane) with the light-emission guide hole 7 with the shield protrusion 4A centered therebetween. The light-reception guide hole 8 includes a vertical hole portion 8A extending along the optical axis O2 of the light-receiving element 13 and a diagonal hole portion 8B that is continuous with the vertical hole portion 8A and that extends in a diagonal direction that coincides with the light-reception axis direction L2. The length of the diagonal hole portion 8B in the light-reception axis direction L2 is preferably larger than the width and the height in directions perpendicular or substantially perpendicular to the light-reception axis direction L2. Thus, the diagonal hole portion 8B is defined by an elongated straight hole.

The light-reception axis direction L2 is inclined from the optical axis O2 (Z-direction) of the light-receiving element 13 toward the light-emitting element 10 and is inclined toward the upper surface side (upper side) with respect to the length direction (X-direction). The smoke monitoring area A is located above the shield protrusion 4A at the location at which the light-emission axis direction L1 and the light-reception axis direction L2 intersect each other. Thus, scattered light from the smoke monitoring area A is guided to the light-receiving element 13 via the light-reception guide hole 8.

The light-reception guide hole 8 includes an element installation portion 8C that opens on the bottom surface side of the housing 2 and a light entrance window 8D that opens on the upper surface side of the housing 2. The light-receiving element is installed in the element installation portion 8C. The scattered light from the smoke monitoring area A enters the light-reception guide hole 8 via the light entrance window 8D. The light entrance window 8D is defined by a portion of the through-hole 6 nearer than the shield protrusion 4A to the other side in the length direction and opens on the upper side of the housing 2.

A first substrate 9 is preferably a flat plate made of an insulating material. An example of the first substrate 9 is a printed circuit board. The first substrate 9 closes the element installation portion 7C of the light-emission guide hole 7 and is attached to the bottom surface of the light-emission-side leg portion 3A of the housing 2.

The light-emitting element 10 is mounted on the first substrate 9 and emits, for example, infrared rays or visible rays. The direction of the optical axis 01 of the light-emitting element 10 is typically the vertical direction (Z-direction), for example, with respect to the first substrate 9. Examples of the light-emitting element 10 include a light-emitting diode (LED), a laser diode (LD), and a vertical cavity surface emitting laser (VCSEL).

The light-emitting element 10 is installed in the housing 2 and inserted in the element installation portion 7C of the light-emission guide hole 7. In the case where the light-emitting element 10 has a large beam divergence angle, a wall surface of the light-emission guide hole 7 is irradiated with some of the light from the light-emitting element 10, which does not reach the smoke monitoring area A. For this reason, the beam divergence angle (divergence angle θ of light) of the light-emitting element 10 is preferably, for example, about 30° or less. Accordingly, a VCSEL, which originally has a small light exit angle (beam divergence angle) as an element, is preferably used as the light-emitting element 10.

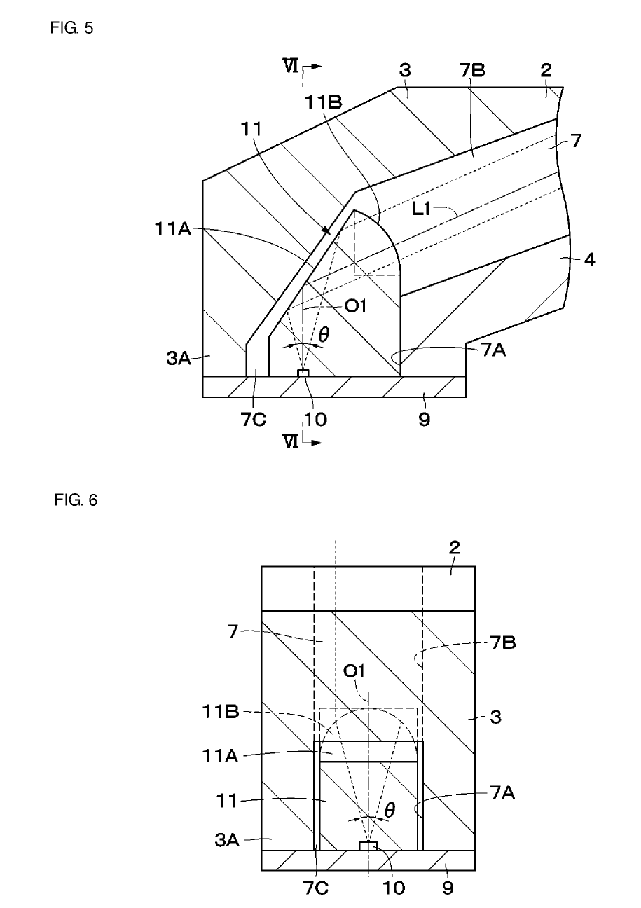

The light-emission-side prism 11 accommodates the light-emitting element 10 and is disposed in the light-emission guide hole 7. The light from the light-emitting element 10 is reflected in the light-emission axis direction L1 by using the light-emission-side prism 11. As illustrated in FIG. 5 and FIG. 6, the light-emission-side prism 11 is provided on the first substrate 9 while containing the light-emitting element 10. The light-emission-side prism 11 is installed in the housing 2 together with the first substrate 9 and inserted in the vertical hole portion 7A.

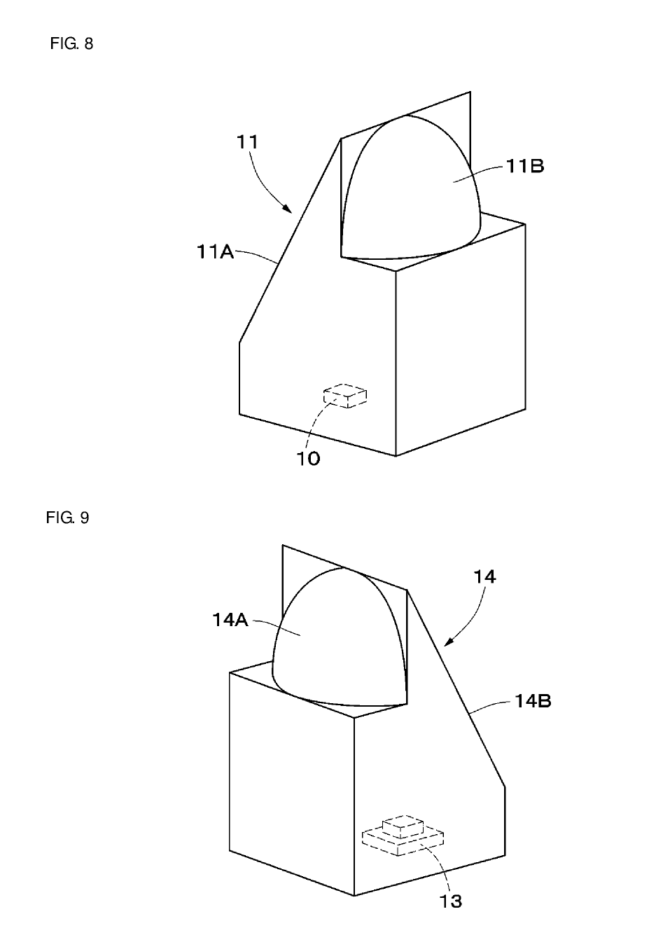

The light-emission-side prism 11 is preferably made of a transparent resin material having a refractive index larger than the refractive index of air. As illustrated in FIG. 5, FIG. 6, and FIG. 8, the light-emission-side prism 11 has a total-reflection surface 11A that causes the light from the light-emitting element 10 to be directed in the light-emission axis direction L1 due to total reflection at an interface with the outside and a lens surface 11B that is located on a light exit surface and that causes light emitted from the total-reflection surface 11A to be condensed.

The total-reflection surface 11A is a flat inclined surface that is inclined from the optical axis O1 of the light-emitting element 10. The total-reflection surface 11A is inclined also from the light-emission axis direction L1. The total-reflection surface 11A has a sufficient area in consideration of the divergence angle θ of light of the light-emitting element 10 such that the light from the light-emitting element 10 is totally reflected. The total-reflection surface 11A is located on the side (left-hand side in FIG. 2) of the vertical hole portion 7A opposite the diagonal hole portion 7B in the length direction (X-direction) and extends so as to be connected to the diagonal hole portion 7B.

The lens surface 11B is preferably, for example, a spherical surface, the center of which corresponds to the light-emission axis direction L1. The lens surface 11B defines a convex lens (spherical surface lens) and is located on the side (right-hand side in FIG. 2) of the vertical hole portion 7A nearer to the diagonal hole portion 7B in the length direction (X-direction). The lens surface 11B is located so as to face the diagonal hole portion 7B. The radius of curvature of the lens surface 11B is preferably, for example, no less than about 1 mm and no more than about 10 mm. The lens surface 11B prevents light that the total-reflection surface 11A reflects from diverging and causes a luminous flux to be condensed in the smoke monitoring area A.

A second substrate 12 is preferably a flat plate made of an insulating material. The second substrate 12 is structured in the same or substantially the same manner as the first substrate 9. An example of the second substrate 12 is a printed circuit board. The second substrate 12 closes the element installation portion 8C of the light-reception guide hole 8 and is attached to the bottom surface of the light-reception-side leg portion 3B of the housing 2.

The light-receiving element 13 is mounted on the second substrate 12 and receives infrared rays or visible rays. Examples of the light-receiving element 13 include a photodiode (PD) and a phototransistor. The light-receiving element 13 is installed in the housing 2 and inserted in the element installation portion 8C of the light-reception guide hole 8.

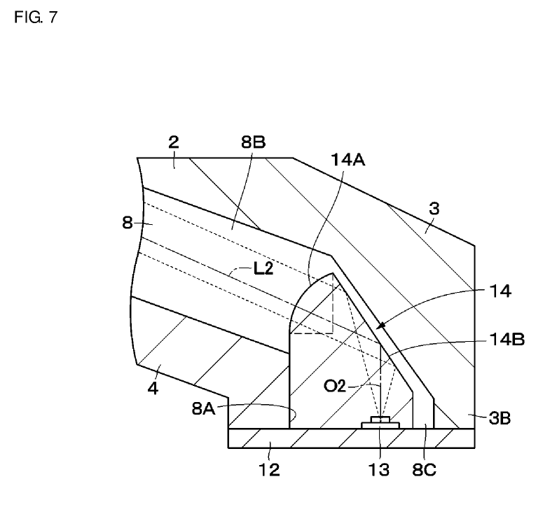

The light-reception-side prism 14 accommodates the light-receiving element 13 and is disposed in the light-reception guide hole 8. The scattered light entering from the smoke monitoring area A in the light-reception axis direction L2 is reflected toward the light-receiving element 13 by using the light-reception-side prism 14. As illustrated in FIG. 7, the light-reception-side prism 14 is provided on the second substrate 12 while containing the light-receiving element 13. The light-reception-side prism 14 is installed in the housing 2 together with the second substrate 12 and inserted in the vertical hole portion 8A.

The light-reception-side prism 14 is preferably made of a transparent resin material having a refractive index larger than the refractive index of air. As illustrated in FIG. 7 and FIG. 9, the light-reception-side prism 14 includes a lens surface 14A that is located on a light entrance surface and that causes the scattered light entering from the smoke monitoring area A in the light-reception axis direction L2 to be condensed and a total-reflection surface 14B that causes light condensed by the lens surface 14A to be directed toward the light-receiving element 13 due to total reflection at an interface with the outside.

The lens surface 14A is preferably, for example, a spherical surface, the center of which corresponds to the light-reception axis direction L2. The lens surface 14A is structured in the same or substantially the same manner as the lens surface 11B and defines a convex lens (spherical surface lens). The lens surface 14A is located on the side (left-hand side in FIG. 2) of the vertical hole portion 8A nearer to the diagonal hole portion 8B in the length direction (X-direction). The lens surface 14A is located so as to face the diagonal hole portion 8B. The lens surface 14A causes the scattered light entering via the light-reception guide hole 8 to be condensed on the total-reflection surface 14B.

The total-reflection surface 14B is a flat inclined surface that is inclined from the optical axis O2 of the light-receiving element 13. The total-reflection surface 14B is inclined also from the light-reception axis direction L2. The total-reflection surface 14B has a sufficient area such that the scattered light entering via the light-reception guide hole 8 is totally reflected. The total-reflection surface 14B is located on the side (right-hand side in FIG. 2) of the vertical hole portion 8A opposite the diagonal hole portion 8B in the length direction (X-direction) and extends so as to be connected to the diagonal hole portion 8B.

The smoke-detecting photosensor 1 according to the first preferred embodiment preferably has the above structure. The operation thereof will now be described.

The smoke-detecting photosensor 1 is attached to a mounting substrate on which a processing circuit defined by, for example, a microprocessor is mounted (not illustrated), and the light-emitting element 10 and the light-receiving element 13 are connected to the processing circuit. The light-emitting element emits light into the light-emission guide hole 7 along the optical axis O1 when a drive power (drive current) is supplied from the processing circuit. The total-reflection surface 11A of the light-emission-side prism 11 disposed in the light-emission guide hole 7 is irradiated with the light from the light-emitting element 10, which is reflected in the light-emission axis direction L1. Thus, the light from the light-emitting element 10 exits from the light-emission guide hole 7 via the light exit window 7D and is supplied to the smoke monitoring area A.

In the case where the smoke monitoring area A contains smoke, the light from the light-emitting element 10 is scattered due to the smoke, resulting in scattered light. Some of the scattered light moves in the light-reception axis direction L2, which is different from the light-emission axis direction L1, and enters the light-reception guide hole 8 via the light entrance window 8D. The total-reflection surface 14B of the light-reception-side prism 14 disposed in the light-reception guide hole 8 is irradiated with the scattered light that enters the light-reception guide hole 8, which is reflected toward the light-receiving element 13. Thus, the light-receiving element 13 is irradiated with the scattered light from the smoke monitoring area A. Accordingly, the light-receiving element 13 outputs a detection signal, such as electric current, in accordance with the intensity of the scattered light. This enables the processing circuit to identify the presence or absence of smoke in the smoke monitoring area A in a manner in which the detection signal outputted from the light-receiving element 13 is monitored.

Thus, according to the first preferred embodiment, the light-emission-side prism 11 accommodates the light-emitting element 10 and is disposed in the light-emission guide hole 7, and the light-reception-side prism 14 accommodates the light-receiving element 13 and is disposed in the light-reception guide hole 8. Since the light-emission-side prism 11 includes the total-reflection surface 11A, total reflection occurs at the total-reflection surface 11A due to a difference in the refractive index between the inside and the outside of the light-emission-side prism 11. For this reason, the light from the light-emitting element 10 is able to be directed in the light-emission axis direction L1 using the total-reflection surface 11A of the light-emission-side prism 11. Thus, the light from the light-emitting element 10 is able to be supplied to the smoke monitoring area A via the light-emission guide hole 7. In addition, since the light-emission-side prism 11 includes the lens surface 11B, the light from the light-emitting element 10 is condensed in the smoke monitoring area A. For this reason, the light is scattered in the smoke monitoring area A even when the output of the light-emitting element 10 is low.

Since the light-reception-side prism 14 includes the total-reflection surface 14B, total reflection occurs at the total-reflection surface 14B due to a difference in the refractive index between the inside and the outside of the light-reception-side prism 14. For this reason, the scattered light entering from the smoke monitoring area A in the light-reception axis direction L2 is able to be directed toward the light-receiving element 13 by using the total-reflection surface 14B of the light-reception-side prism 14. Thus, the scattered light entering via the light-reception guide hole 8 is able to be supplied to the light-receiving element 13. In addition, since the light-reception-side prism 14 includes the lens surface 14A, a luminous flux is condensed on the light-receiving element 13. For this reason, the scattered light is condensed on the light-receiving element 13 and detected even when the scattered light in the smoke monitoring area A is weak. Consequently, the light-emitting element 10 is able to be operated with a low output, and energy consumption is decreased.

The light-emission-side prism 11 and the light-reception-side prism 14 may preferably be manufactured by transparent resin molding, such as transfer molding, for example, and have a small variation in the refractive index over time. For this reason, the reflectance of the light-emission-side prism 11 and the light-reception-side prism 14 does not significantly change, and high reliability is achieved.

In addition, the light-emission-side prism 11 may preferably be made in a manner in which the light-emitting element 10 is mounted on the first substrate 9, and a transparent resin is collectively molded thereon. Similarly, the light-reception-side prism 14 may preferably be made in a manner in which the light-receiving element 13 is mounted on the second substrate 12, and a transparent resin is collectively molded thereon. For this reason, a complex assembling process is not necessary, which is suitable for mass production and enables a decrease in size.

The light-emission-side prism 11 accommodates the light-emitting element 10, and the light-reception-side prism 14 accommodates the light-receiving element 13. For this reason, the accuracy of positioning of the prisms 11 and 14 and the elements 10 and 13 is higher than that in the case where the prisms 11 and 14 and the elements 10 and 13 are separately installed, and the light collection efficiency of the scattered light to the light-receiving element 13 is able to be increased.

The total-reflection surface 11A of the light-emission-side prism 11 is preferably a flat inclined surface that is inclined from the optical axis O1 of the light-emitting element 10. For this reason, the light from the light-emitting element 10 is directed in the light-emission axis direction L1 by using the light-emission-side prism 11 due to total reflection at the inclined total-reflection surface 11A. Even when the light from the light-emitting element 10 tends to diverge in the horizontal direction more than in the vertical direction, the lens surface 11B of the light-emission-side prism 11 inhibits the light from diverging in the horizontal direction, and the light from the light-emitting element 10 is able to be condensed in the smoke monitoring area A.

Similarly, the total-reflection surface 14B of the light-reception-side prism 14 is preferably a flat inclined surface that is inclined from the optical axis O2 of the light-receiving element 13. For this reason, the scattered light entering from the smoke monitoring area A in the light-reception axis direction L2 is directed toward the light-receiving element 13 due to total reflection at the inclined total-reflection surface 14B of the light-reception-side prism 14. However, the total-reflection surface 14B, which is the flat inclined surface, does not provide the condensing effect. In contrast, the light-reception-side prism 14, which includes the lens surface 14A, enables the scattered light entering from the smoke monitoring area A in the light-reception axis direction L2 to be condensed on the light-receiving element 13 due to the condensing effect of the lens surface 14A.

The inclination of light may be changed in a manner in which the inclinations of the total-reflection surfaces 11A and 14B are changed. In addition to this, the shapes of the lens surfaces 11B and 14A enable the divergence angle of light to be decreased. For this reason, fine adjustments to sensitivity is able to be made in accordance with the kinds of smoke in a manner in which the shapes of the prisms 11 and 14, for example, are appropriately determined.

Since the divergence angle θ of light of the light-emitting element 10 is preferably about 30° or less, for example, the light emitted from the light-emitting element 10 is able to be totally reflected by the small light-emission-side prism 11, unlike the case where the divergence angle θ of light is large.

The direction of the optical axis C1 of the light-emitting element 10 is the vertical or substantially vertical direction perpendicular or substantially perpendicular to the first substrate 9, and the direction of the optical axis O2 of the light-receiving element 13 is the vertical or substantially vertical direction perpendicular or substantially perpendicular to the second substrate 12. Since the light from the light-emitting element 10 is reflected in the light-emission axis direction L1 by using the light-emission-side prism 11, the light emitted along the optical axis O1 of the light-emitting element 10 is condensed in the smoke monitoring area A. Since the scattered light entering in the light-reception axis direction L2 is reflected toward the light-receiving element 13 by using the light-reception-side prism 14, the scattered light in the smoke monitoring area A is incident on the light-receiving element 13 along the optical axis O2.

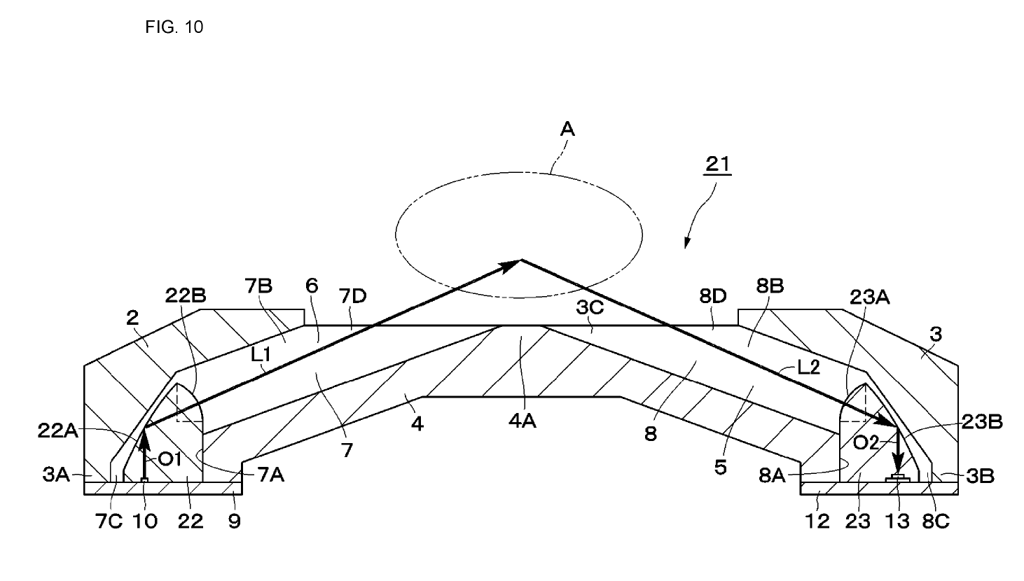

A second preferred embodiment of the present invention will now be described with reference to FIG. 10 to FIG. 14. In the second preferred embodiment, the total-reflection surface of the light-emission-side prism is preferably a toroid surface including curvatures different between the vertical direction parallel or substantially parallel to the optical axis of the light-emitting element and the horizontal direction perpendicular or substantially perpendicular to the optical axis of the light-emitting element, and the radius of curvature of the total-reflection surface in the vertical direction is preferably larger than the radius of curvature of the total-reflection surface in the horizontal direction. In the second preferred embodiment, components similar to those in the first preferred embodiment are designated by the same reference signs, and a description thereof is omitted.

A smoke-detecting photosensor 21 according to the second preferred embodiment preferably has substantially the same structure as the smoke-detecting photosensor 1 according to the first preferred embodiment. The smoke-detecting photosensor 21 includes the housing 2, the light-emission guide hole 7, the light-reception guide hole 8, the light-emitting element 10, the light-receiving element 13, a light-emission-side prism 22, and a light-reception-side prism 23.

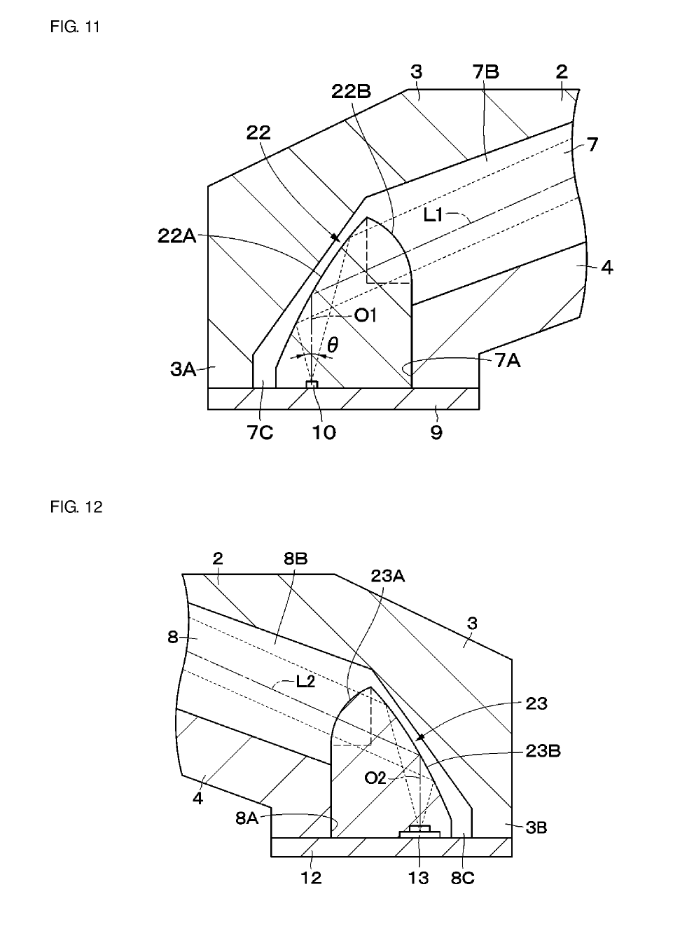

The light-emission-side prism 22 accommodates the light-emitting element 10 and is disposed in the light-emission guide hole 7. The light from the light-emitting element 10 is reflected in the light-emission axis direction L1 by using the light-emission-side prism 22. As illustrated in FIG. 10 and FIG. 11, the light-emission-side prism 22 is provided on the first substrate 9 while containing the light-emitting element 10. The light-emission-side prism 22 is installed in the housing 2 together with the first substrate 9 and inserted in the vertical hole portion 7A.

The light-emission-side prism 22 is preferably made of a transparent resin material having a refractive index larger than the refractive index of air. The light-emission-side prism 22 includes a total-reflection surface 22A that causes the light from the light-emitting element 10 to be directed in the light-emission axis direction L1 due to total reflection at an interface with the outside and a lens surface 22B that is located on a light exit surface and that causes light emitted from the total-reflection surface 22A to be condensed.

The total-reflection surface 22A has a sufficient area in consideration of the divergence angle θ of light of the light-emitting element 10 such that the light from the light-emitting element 10 is totally reflected. The total-reflection surface 22A is located on the side (left-hand side in FIG. 10) of the vertical hole portion 7A opposite the diagonal hole portion 7B in the length direction (X-direction) and extends so as to be connected to the diagonal hole portion 7B.

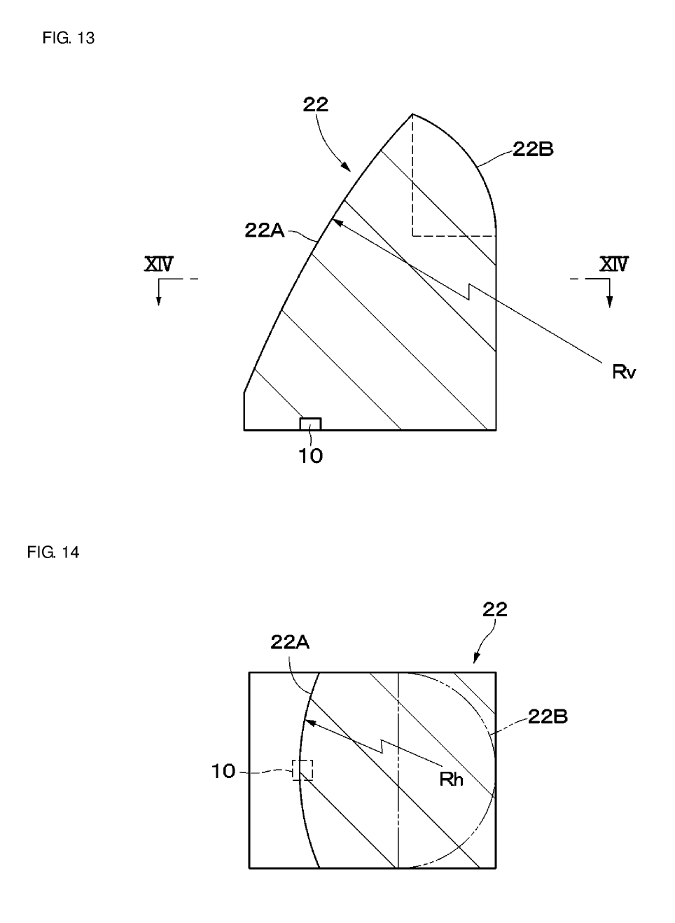

The total-reflection surface 22A is preferably a toroid surface including curvatures different between the vertical or substantially vertical direction parallel or substantially parallel to the optical axis O1 of the light-emitting element 10 and the horizontal or substantially horizontal direction perpendicular or substantially perpendicular to the optical axis of the light-emitting element 10. As illustrated in FIG. 13 and FIG. 14, the total-reflection surface 22A of the light-emission-side prism 22 is preferably structured such that a radius of curvature Rv in the vertical direction (height direction) is larger than a radius of curvature Rh in the horizontal direction (width direction). Specifically, the radius of curvature Rv (for example, Rv is about 10 mm to about 12 mm) is preferably more than twice the radius of curvature Rh (for example, Rv is about 2 mm to about 4 mm).

The lens surface 22B is the same or substantially the same as the lens surface 11B according to the first preferred embodiment. The lens surface 22B is preferably, for example, a spherical surface, the center of which corresponds to the light-emission axis direction L1. The lens surface 22B defines a convex lens (spherical surface lens) and is located on the side (right-hand side in FIG. 10) of the vertical hole portion 7A nearer to the diagonal hole portion 7B in the length direction (X-direction). The lens surface 22B is located so as to face the diagonal hole portion 7B. The lens surface 22B inhibits light that the total-reflection surface 22A reflects from diverging and causes a luminous flux to be condensed in the smoke monitoring area A.

The light emitted from the light-emission-side prism 22 is similar to parallel light due to the condensing effect of the total-reflection surface 22A and the lens surface 22B. Consequently, the light-emission-side prism 22 inhibits the light from the light-emitting element 10 from diverging in the width direction of the light-emission guide hole 7, and the light is able to be supplied from the light exit window 7D to the smoke monitoring area A as much as possible. Detection characteristics that exhibit low current consumption and high sensitivity are achieved in a manner in which the radiuses of curvature Rv and Rh are adjusted to condense light.

The light-reception-side prism 23 accommodates the light-receiving element 13 and is disposed in the light-reception guide hole 8. The scattered light entering from the smoke monitoring area A in the light-reception axis direction L2 is reflected toward the light-receiving element 13 by using the light-reception-side prism 23. As illustrated in FIG. 12, the light-reception-side prism 23 is provided on the second substrate 12 while containing the light-receiving element 13. The light-reception-side prism 23 is installed in the housing 2 together with the second substrate 12 and inserted in the vertical hole portion 8A.

The light-reception-side prism 23 is preferably made of a transparent resin material having a refractive index larger than the refractive index of air. The light-reception-side prism 23 includes a lens surface 23A that is located on a light entrance surface and that causes the scattered light entering from the smoke monitoring area A in the light-reception axis direction L2 to be condensed and a total-reflection surface 23B that causes light condensed by the lens surface 23A to be directed toward the light-receiving element 13 due to total reflection at an interface with the outside.

The light-reception-side prism 23 has the same or substantially the same shape (bilaterally symmetric shape in FIG. 10) as the light-emission-side prism 22. The lens surface 23A is preferably, for example, a spherical surface, the center of which corresponds to the light-reception axis direction L2. The lens surface 23A defines a convex lens (spherical surface lens) and is located on the side (left-hand side in FIG. 10) of the vertical hole portion 8A nearer to the diagonal hole portion 8B in the length direction (X-direction). The lens surface 23A is located so as to face the diagonal hole portion 8B. The lens surface 23A causes the scattered light entering via the light-reception guide hole 8 to be condensed on the total-reflection surface 23B.

The total-reflection surface 23B is curved with respect to the vertical or substantially vertical direction parallel or substantially parallel to the optical axis O2 of the light-receiving element 13 and is also curved with respect to the horizontal or substantially horizontal direction perpendicular or substantially perpendicular to the optical axis O2 of the light-receiving element 13. The total-reflection surface 23B is preferably a toroid surface including curvatures different between the vertical or substantially vertical direction parallel or substantially parallel to the optical axis O2 of the light-receiving element 13 and the horizontal or substantially horizontal direction perpendicular or substantially perpendicular to the optical axis O2 of the light-receiving element 13. The total-reflection surface 23B is preferably structured such that the radius of curvature in the vertical direction (height direction) is larger than the radius of curvature in the horizontal direction (width direction). When the scattered light enters the light-reception guide hole 8 from the smoke monitoring area A via the light entrance window 8D, the scattered light is condensed by the lens surface 23A and the total-reflection surface 23B. Thus, the total-reflection surface 23B enables the scattered light to be effectively supplied to the light-receiving element 13.

The total-reflection surface 23B has a sufficient area such that the scattered light entering via the light-reception guide hole 8 is totally reflected. The total-reflection surface 23B is located on the side (right-hand side in FIG. 10) of the vertical hole portion 8A opposite the diagonal hole portion 8B in the length direction (X-direction) and extends so as to be connected to the diagonal hole portion 8B.

According to the second preferred embodiment, the same or substantially the same effects as in the first preferred embodiment are achieved. According to the second preferred embodiment, the total-reflection surface 22A of the light-emission-side prism 22 is preferably a toroid surface including curvatures different between the vertical or substantially vertical direction parallel or substantially parallel to the optical axis O1 of the light-emitting element 10 and the horizontal or substantially horizontal direction perpendicular or substantially perpendicular to the optical axis O1 of the light-emitting element 10, and the radius of curvature Rv of the total-reflection surface in the vertical direction is larger than the radius of curvature Rh of the total-reflection surface in the horizontal direction. For this reason, even when the light from the light-emitting element 10 tends to diverge in the horizontal direction more than in the vertical direction, the light-emission-side prism 22 including the total-reflection surface 22A, which is the toroid surface, prevents the light from diverging in the horizontal direction, and the light from the light-emitting element 10 is able to be condensed in the smoke monitoring area A.

According to the second preferred embodiment, the total-reflection surface 23B of the light-reception-side prism 23 is preferably a toroid surface as in the total-reflection surface 22A of the light-emission-side prism 22. However, the present invention is not limited thereto. The total-reflection surface of the light-reception-side prism may be an inclined surface as in the first preferred embodiment. The smoke-detecting photosensor according to the first preferred embodiment may include the light-reception-side prism 23 according to the second preferred embodiment, instead of the light-reception-side prism 14.

According to the first preferred embodiment, the first substrate 9 and the second substrate 12 are separately disposed, the light-emitting element 10 and the light-emission-side prism 11 are mounted on the first substrate 9, and the light-receiving element 13 and the light-reception-side prism 14 are mounted on the second substrate 12. The present invention is not limited thereto. The light-emitting element 10 and the light-receiving element 13 may be mounted on a substrate including the first substrate 9 and the second substrate 12 that are coupled with each other. This structure may also be used for the second preferred embodiment.

The above preferred embodiments are described by way of example. The structures described according to the preferred embodiments may be partially replaced or combined.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A smoke-detecting photosensor that irradiates a smoke monitoring area with light, the smoke-detecting photosensor comprising:
a light-emitting element that emits the light;
a light-receiving element that detects scattered light of the light emitted from the light-emitting element due to a smoke particle;
a housing in which the light-emitting element and the light-receiving element are disposed on one surface side thereof;
a light-emission guide hole that is provided in the housing, that extends in a light-emission axis direction different from an optical axis of the light-emitting element, and through which the light from the light-emitting element is guided to the smoke monitoring area on the other surface side;
a light-reception guide hole that is provided in the housing, that extends in a light-reception axis direction different from the light-emission axis direction and different from an optical axis of the light-receiving element, and through which scattered light from the smoke monitoring area is guided to the light-receiving element;
a light-emission-side prism that accommodates the light-emitting element and that is disposed in the light-emission guide hole; and
a light-reception-side prism that accommodates the light-receiving element and that is disposed in the light-reception guide hole; wherein
the light-emission-side prism includes a total-reflection surface that causes the light from the light-emitting element to be directed in the light-emission axis direction due to total reflection at an interface with an outside, and a lens surface that is located on a light exit surface and that causes light emitted from the total-reflection surface to be condensed; and
the light-reception-side prism includes a lens surface that is located on a light entrance surface and that causes the scattered light entering from the smoke monitoring area in the light-reception axis direction to be condensed and a total-reflection surface that causes light condensed by the lens surface to be directed toward the light-receiving element due to total reflection at an interface with the outside.

2. The smoke-detecting photosensor according to claim 1, wherein the total-reflection surface of the light-emission-side prism is a flat inclined surface that is inclined from the optical axis of the light-emitting element.

3. The smoke-detecting photosensor according to claim 1, wherein the total-reflection surface of the light-emission-side prism is a toroid surface including curvatures different between a vertical or substantially vertical direction parallel or substantially parallel to the optical axis of the light-emitting element and a horizontal or substantially horizontal direction perpendicular or substantially perpendicular to the optical axis of the light-emitting element, and a radius of curvature of the total-reflection surface in the vertical or substantially vertical direction is larger than a radius of curvature of the total-reflection surface in the horizontal or substantially horizontal direction.

4. The smoke-detecting photosensor according to claim 1, wherein a divergence angle of light of the light-emitting element is about 30° or less.

5. The smoke-detecting photosensor according to claim 1, wherein
the light-emitting element and the light-emission-side prism are mounted on a first substrate, and a direction of the optical axis of the light-emitting element is a vertical or substantially vertical direction perpendicular or substantially perpendicular to the first substrate; and
the light-receiving element and the light-reception-side prism are mounted on a second substrate, and a direction of the optical axis of the light-receiving element is the vertical or substantially vertical direction perpendicular or substantially perpendicular to the second substrate.

6. The smoke-detecting photosensor according to claim 1, wherein the total-reflection surface of the light-reception-side prism is a flat inclined surface that is inclined relative to the optical axis of the light-receiving element.

7. The smoke-detecting photosensor according to claim 1, wherein the total-reflection surface of the light-reception-side prism is a toroid surface including curvatures different between a vertical or substantially vertical direction parallel or substantially parallel to the optical axis of the light-receiving element and a horizontal or substantially horizontal direction perpendicular or substantially perpendicular to the optical axis of the light-receiving element, and a radius of curvature of the total-reflection surface in the vertical or substantially vertical direction is larger than a radius of curvature of the total-reflection surface in the horizontal or substantially horizontal direction.

8. The smoke-detecting photosensor according to claim 1, wherein a shield protrusion is provided in a central portion of the housing between the light-emission guide hole and the light-reception guide hole.

9. The smoke-detecting photosensor according to claim 8, wherein the light-reception guide hole is symmetric with the light-emission guide hole with the shield protrusion centered therebetween.

10. The smoke-detecting photosensor according to claim 1, wherein the light-emission guide hole includes an element installation portion that opens to a bottom surface of the housing, and a light exit window that opens to an upper surface of the housing.

11. The smoke-detecting photosensor according to claim 1, wherein the light-reception guide hole includes an element installation portion that opens to a bottom surface of the housing and a light entrance window that opens to an upper surface side of the housing.

12. The smoke-detecting photosensor according to claim 5, wherein the first substrate is a printed circuit board.

13. The smoke-detecting photosensor according to claim 5, wherein the second substrate is a printed circuit board.

14. The smoke-detecting photosensor according to claim 1, wherein the light-emitting element is one of a light-emitting diode, a laser diode, and a vertical cavity surface emitting laser.

15. The smoke-detecting photosensor according to claim 1, wherein the light-emission-side prism is made of a transparent resin material having a refractive index larger than a refractive index of air.

16. The smoke-detecting photosensor according to claim 1, wherein the light-reception-side prism is made of a transparent resin material having a refractive index larger than a refractive index of air.

17. The smoke-detecting photosensor according to claim 1, wherein the lens surface of the light-emission-side prism is a spherical surface.

18. The smoke-detecting photosensor according to claim 1, wherein the lens surface of the light-reception-side prism is a spherical surface.
